(19) United States
(12) Patent Application Publication
(10) Pub. No.: US 2012/0270459 A1
(43) Pub. Date: Oct. 25, 2012

(54) NONWOVEN MATERIAL AND METHOD OF FABRICATING THE NONWOVEN MATERIAL

(76) Inventor: Yuan-Shan ZHU, DongShan Township (TW)

(21) Appl. No.: 13/089,663

(22) Filed: Apr. 19, 2011

(51) Int. Cl. B32B 5/26; B32B 27/34; B32B 27/40; B32B 37/10; B32B 27/08; B32B 37/02; B05D 3/00; B32B 37/06; D04H 13/00; B32B 27/02

(52) U.S. Cl. 442/400; 442/327; 442/415; 156/308.2; 427/398.1

(57) ABSTRACT

The present invention is a nonwoven material and a method of fabricating the nonwoven material. The material comprises a nylon fabric layer and at least one nonwoven fabric layer combined with the nylon layer. The method of fabricating the nonwoven material comprises steps of combining a nonwoven fabric layer with a nylon layer, hot-pressing the nonwoven fabric layer with the nylon layer and cooling the hot-pressed the nonwoven fabric layer and the nylon layer.

### FIELD OF THE INVENTION

The present invention is a nonwoven material and a method of fabricating the nonwoven material. Specifically, the nonwoven material combines nonwoven fabric and nylon fabric.

### BACKGROUND OF THE INVENTION

Nonwoven fabric is a fabric that is made of fibers held together mechanically or thermally. Common methods of fabricating a nonwoven fabric include interlocking fibers to form a stronger fabric and melt-blowing melted fibers to directly attach the fibers to a target and form a sheet. A nonwoven fabric that is melt-blown is called a melt-blown nonwoven fabric.

Because fibers for making nonwoven fabrics including polyvinyl chloride (PVC), polyethylene (PE), ethylene vinyl acetate copolymer (EVA), polyvinyl alcohol (PVA), etc. cost less, nonwoven fabrics are generally cheaper than conventional woven fabrics and have numerous applications in clothing industries.

Although nonwoven fabric cost less, some problems still exist with nonwoven fabric including lack of flexibility, low tear-strength and insufficient elongation. Hence to overcome the foregoing problems is an objective for research.

### SUMMARY OF THE INVENTION

The objective of the present invention is to provide a nonwoven material and a method of fabricating a nonwoven material that improves flexibility, tear-strength and elongation.

The nonwoven material comprises at least one nylon fabric layer and a nonwoven fabric layer. The nylon fabric layer and the nonwoven fabric layer are combined.

The method of fabricating the nonwoven material comprises steps of combining a nylon fabric layer with at least one nonwoven fabric layer; hot-pressing the nylon fabric layer and the at least one nonwoven fabric layer; and cooling the combined nylon fabric layer and the at least one nonwoven fabric layer.

The nonwoven material in accordance with the present invention improves flexibility, tear-strength and elongation in comparison with conventional nonwoven fabrics.

### BRIEF DESCRIPTION OF THE DRAWINGS

FIG. 1 is a cross sectional side view of a first embodiment of a nonwoven material in accordance with the present invention;

FIG. 2 is a schematic diagram of the method of fabricating the nonwoven material in accordance with the present invention; and

FIG. 3 is a cross sectional side view of a second embodiment of a nonwoven material in accordance with the present invention.

### DETAILED DESCRIPTION OF THE PRESENT INVENTION

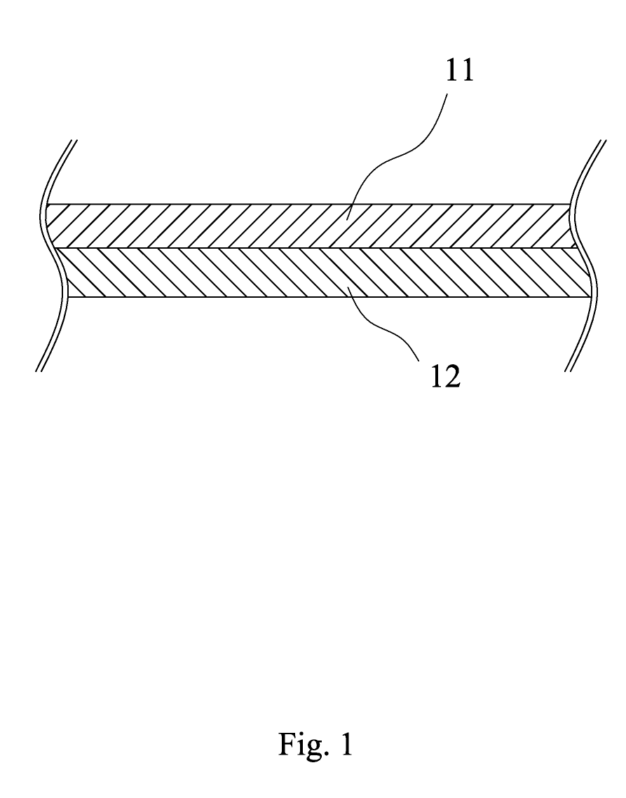

With reference to FIG. 1, a first embodiment of a nonwoven material in accordance with the present invention comprises a nylon fabric layer (11) and a nonwoven fabric layer (12) that is combined with the nylon fabric layer (11). The nonwoven fabric layer (12) is made of thermoplastic polyurethane (TPU) mixed with polypropylene (PP), polyethylene (PE) or nylon. Different tear-strength and elongation can be achieved by varying proportions of each mixture.

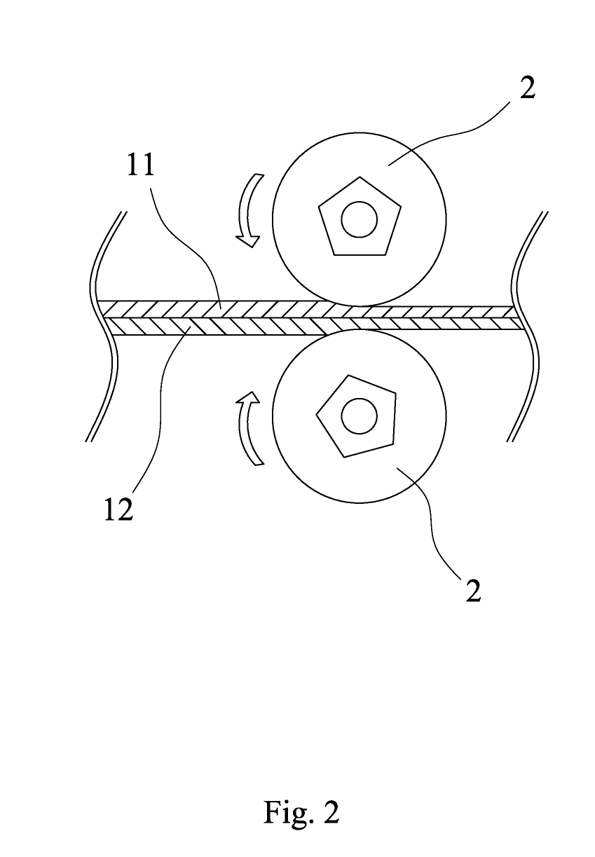

With further reference to FIG. 2, a method of fabricating the nonwoven material comprises steps of combining a nylon fabric layer (11) with at least one nonwoven fabric layer (12), hot-pressing the nylon fabric layer (11) and the at least one nonwoven fabric layer (12), and cooling the combined nylon fabric layer (11) and the at least one nonwoven fabric layer (12).

The step of combining the nylon fabric layer (11) with the at least one nonwoven fabric layer (12) comprises melt-blowing, coating or laminating the at least one nonwoven fabric layer (12) on the nylon fabric layer (11).

The step of hot-pressing the nylon fabric layer (11) and the at least one nonwoven fabric layer (12) smoothes the combined nylon and nonwoven fabric layers (11 and 12) and hot-presses the combined nylon and nonwoven fabric layers (11 and 12) with two hot rollers (2) having temperatures of 100° C. to 130° C.

The step of cooling the nylon fabric layer (11) and the at least one nonwoven fabric layer (12) cools the hot-pressed nylon and nonwoven fabric layers (11 and 12) to 25° C. and soaks the hot-pressed nylon and nonwoven fabric layers (11 and 12) in cool water or places the hot-pressed nylon and nonwoven fabric layers (11 and 12) at room temperature.

TABLE 1

| | | Tensile | Tear | Air |
|---|---|---|---|---|
| | Elongation | Strength | Strength | Permeability |
| | % | gf/mm² | gf | cm³/cm²/sec |
| Nylon Fabric | 1845 | 656 | 1543 | >1000 |
| Nonwoven Fabric | 1037 | 173 | 256 | ≈200 |
| First-Embodiment | 1437 | 844 | 2106 | ≈50~100 |

Table 1 is experimental data obtained by testing a nylon fabric, a conventional nonwoven fabric and the first embodiment of the nonwoven material in accordance with the present invention with regard to elongation, tensile-strength, tear-strength and air-permeability. With reference to Table 1, the nylon fabric has high elongation, tensile-strength, tear-strength and air-permeability, while the conventional nonwoven fabric has low elongation, tensile-strength, tear-strength and air-permeability. The first embodiment in accordance with the present invention has higher elongation, tensile-strength and tear-strength than the conventional nonwoven fabric.

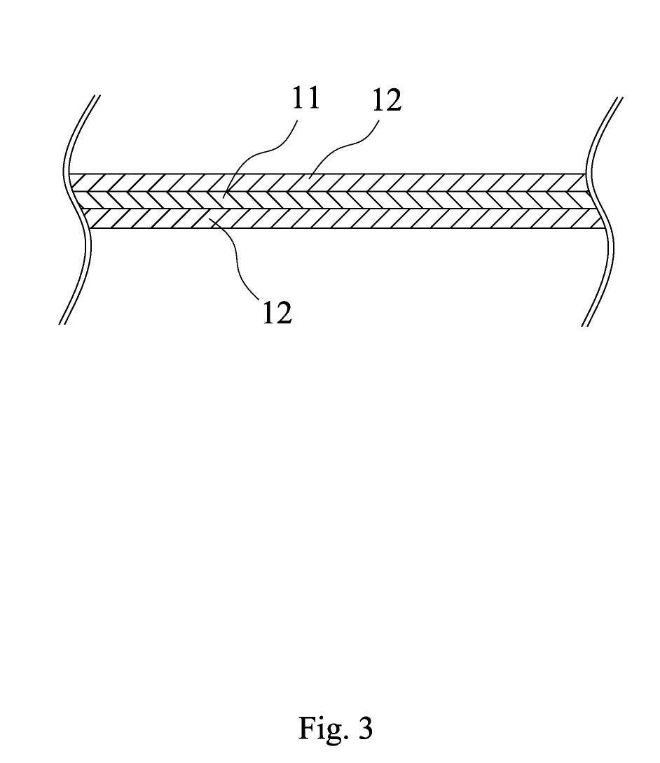

With further reference to FIG. 3, a second embodiment of a nonwoven material in accordance with the present invention comprises two nonwoven fabric layers (12) and a nylon fabric layer (11) sandwiched between and combined with the nonwoven fabric layers (12).

TABLE 2

| | | Tensile | Tear | Air |
|---|---|---|---|---|
| | Elongation | Strength | Strength | Permeability |
| | % | gf/mm² | gf | cm³/cm²/sec |
| First-Embodiment | 1437 | 844 | 2106 | ≈50~100 |
| Second-Embodiment | 904 | 536 | 1658 | ≈50~100 |

Table 2 is experimental data obtained by testing the first and second embodiments of the nonwoven material in accordance with the present invention with regard to elongation, tensile-strength, tear-strength and air-permeability. With reference to Table 2, the second embodiment has lower elongation, tensile-strength and tear-strength than the first embodiment.

Other embodiments of the nonwoven material in accordance with the present invention with different elongation, tensile-strength and tear-strength can be achieved by combining more nylon fabric layers (11) or nonwoven fabric layers (12).

What is claimed is:

1. A nonwoven material comprising
a nylon fabric layer; and
a nonwoven fabric layer being combined with the nylon fabric layer.

2. The nonwoven material as claimed in claim 1, wherein the nonwoven fabric layer is made from melt-blown nonwoven fabric.

3. The nonwoven material as claimed in claim 1, wherein the nonwoven fabric layer is made of thermoplastic polyurethane (TPU).

4. A method of fabricating a nonwoven material comprising steps of
combining a nonwoven fabric layer with a nylon fabric layer;
hot-pressing the nonwoven fabric layer and the nylon fabric layer; and
cooling the nonwoven fabric layer and the nylon fabric layer.

5. The method of fabricating a nonwoven material as claimed in claim 4, wherein the step of combining a nonwoven fabric layer with a nylon fabric layer comprises melt-blowing the nonwoven fabric layer onto the nylon fabric layer.

6. The method of fabricating a nonwoven material as claimed in claim 4, wherein the step of combining a nonwoven fabric layer with a nylon fabric layer comprises coating the nonwoven fabric layer onto the nylon fabric layer.

7. The method of fabricating a nonwoven material as claimed in claim 4, wherein the step of combining a nonwoven fabric layer with a nylon fabric layer comprises laminating the nonwoven fabric layer onto the nylon fabric layer.

8. The method of fabricating a nonwoven material as claimed in claim 4, wherein the step of hot-pressing the nonwoven fabric layer and the nylon fabric layer comprises a step of hot-pressing the nonwoven fabric layer and the nylon fabric layer by using two hot rollers.

9. The method of fabricating a nonwoven material as claimed in claim 4, wherein the step of hot-pressing the nonwoven fabric layer and the nylon fabric layer is performed at a temperature of 100° C. to 130° C.

10. The method of fabricating a nonwoven material as claimed in claim 4, wherein the step of cooling the nonwoven fabric layer and the nylon fabric layer cools the hot-pressed nonwoven fabric layer and the nylon fabric layer to 25° C.
